(19) United States
(12) Patent Application Publication
(10) Pub. No.: US 2007/0296929 A1
(43) Pub. Date: Dec. 27, 2007

(54) Power source unit for projection type display device and projection type display including the same

(75) Inventors: Katsuaki Okubo, Tokyo (JP); Akimitsu Ishizuka, Tokyo (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/633,881

(22) Filed: Dec. 4, 2006

(30) Foreign Application Priority Data
Jun. 21, 2006 (JP) 2006-171948

(51) Int. Cl. G03B 21/16

(52) U.S. Cl. 353/61

(57) ABSTRACT

Each of a power source unit for a projection type display device, and the projection type display device having the same of the present invention includes a box (91) for accommodating therein a substrate (92) having heating elements (92b) mounted thereto, a fan (94) for a lamp power source which causes air to flow into the box (91), a partitioning portion (95b) for partitioning the inside of the box (91), and discharge holes (95d) which are formed in the partitioning portion (95b) and through which the air is blown to the heating elements (92b).

The present application is based on Japanese patent application No. 2006-171948, the entire contents of which are incorporated herein by reference.

### BACKGROUND

1. Field

One embodiment of the invention relates to a power source unit for a main power source, a lamp power source or the like of a projection type display device, and the projection type display device including the same.

2. Description of the Related Art

Heretofore, there has been known a projection type display device in which a light emitted from a lamp is radiated to a liquid crystal panel or the like, light and shade of a light is obtained from the light thus radiated every pixel in the liquid crystal panel by performing light intensity modulation to form an optical image, and the resulting optical image is projected in an enlarged form on a screen or the like. This projection type display device, for example, is disclosed in the Japanese Patent Kokai No. 11-119181. This sort of projection type display device is provided with a power source unit for a main power source, a lamp power source or the like.

In the projection type display device described in the Japanese Patent Kokai No. 11-119181, a main power source unit and a light source lamp unit are cooled by using one sirocco fan. The main power source unit and the light source lamp unit have a box in which a substrate is accommodated, and heating elements are mounted to the substrate. In that projection type display device, an air delivery pipe which branches into two parts is provided on a downstream side of the sirocco fan. Thus, air sent out from the sirocco fan is guided to be distributed to the power source unit and the lamp power source unit through the two parts into which the air delivery pipe branches, respectively.

However, in the projection type display device described in the Japanese Patent Kokai NQ. 11-119181, fans each having a sufficient performance of sending the air must be provided in order to cool the insides of the main power source unit and the lamp power source unit, respectively. As a result, a space which these fans occupy becomes large, and thus a space efficiency in the projection type display device is reduced. In addition, enhancement of the air sending performance of the fan results in that noises and power consumption during the driving of the fans increase.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view showing an internal construction of a device main body of a projection type display device according to an embodiment of the invention;

FIG. 2 is an exemplary partial perspective view showing the projection type display device according to the embodiment of the invention;

FIG. 3 is an exemplary perspective view showing a lamp power source unit of the projection type display device according to the embodiment of the invention;

FIG. 4 is an exemplary exploded perspective view showing the lamp power source unit of the projection type display device according to the embodiment of the invention;

FIG. 5 is an exemplary partial cross sectional view showing a flow of air caused by a fan for a lamp power source of the projection type display device according to the embodiment of the invention;

FIG. 6 is an exemplary partial cross sectional view showing a flow of air caused by a fan for a main power source of the projection type display device according to the embodiment of the invention;

FIG. 7 is an exemplary perspective view showing a guiding member having a duct defining portion, and a cooling fan for a power source of the projection type display device according to the embodiment of the invention;

FIG. 8 is an exemplary perspective view showing a lamp holder of the projection type display device according to the embodiment of the invention;

FIG. 9 is an exemplary perspective view showing another lamp holder of the projection type display device according to the embodiment of the present invention; and

FIG. 10 is an exemplary partial cross sectional view showing a flow of air sent out from the fan for a main power source of the projection type display device according to the embodiment of the invention.

### DETAILED DESCRIPTION OF PREFERRED EMBODIMENTS

Various embodiments according to the invention will be described hereinafter with reference to the accompanying drawings. In general, according to one embodiment of the invention, there is provided a power source unit for a projection type display device, including: a box for accommodating therein a substrate having a heating element mounted therein; a fan for causing air to flow into the box; and a partitioning portion for partitioning an inside of the box, a discharge hole through which the air is blown to the heating element being formed in the partitioning portion.

In addition, according to one embodiment of the invention, there is provided a power source unit for a projection type display device, including: a box for accommodating therein a substrate having a heating element mounted therein, one face of the box being opened; a fan for causing air to flow into the box; a closing member for closing the opening of the box; and a partitioning portion for partitioning an inside of the box, a discharge hole through which the air is blown to the heating element being formed in the partitioning portion.

According to the power source unit for a projection type display device of the invention, when the fan is driven, the air is caused to flow into the box. Also, since the air thus flowed into the box is discharged toward the heating element through the discharge hole formed in the partitioning portion, air is not discharged to any of portions which do not need to be cooled, and thus each of the heating portions in the power source unit can be efficiently cooled. At this time, since the circulation path of the air is narrowed by the discharge hole, a high flow velocity can be obtained during the discharge of the air.

Moreover, according to one embodiment of the invention, there is provided a projection type display device, including: power source unit including a box for accommodating therein a substrate having a heating element mounted therein, a fan for causing air to flow into the box, and a partitioning portion for partitioning an inside of the box, a discharge hole through which the air is blown to the heating element being formed in the partitioning portion; a lamp unit disposed to be adjacent to the power source unit; and a communication hole formed in the power source unit, the air in the box being caused to flow out to an inside of the lamp unit through the communication hole.

According to the projection type display device of the invention, not only the power source unit can be efficiently cooled, but also the air flowed out to the inside of the lamp unit through the communication hole can cool the lamp unit.

According to one embodiment of the invention, each of the heating portions disposed within the power source unit can be efficiently cooled to lighten the burden imposed on the fan, and thus miniaturization of the fan and reduction in noises and power consumption can be realized.

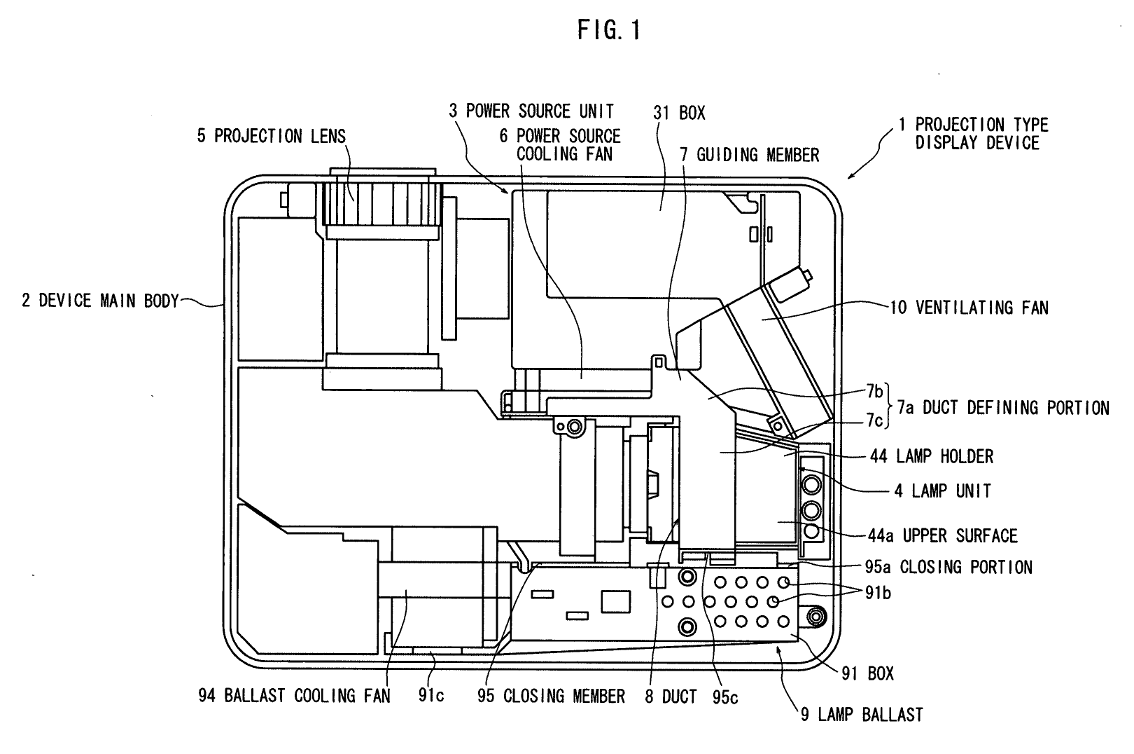

FIGS. 1 to 10 show a projection type display device according to an embodiment of the invention, and FIG. 1 is a schematic plan view explaining constituent elements disposed in a device main body of the projection type display device according to the embodiment of the invention.

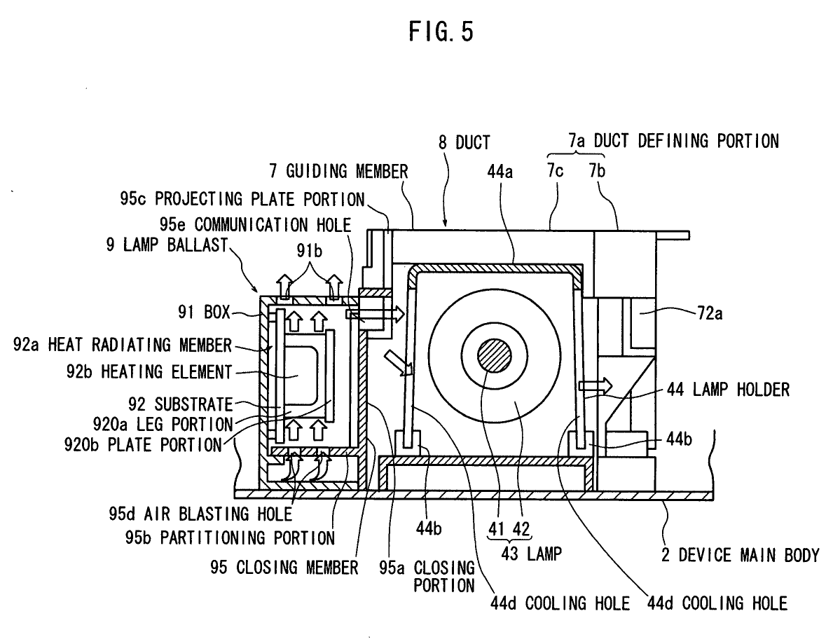

As shown in FIG. 1, a projection type display device 1 includes a chassis-shaped device main body 2, and a main power source unit 3 and a lamp unit 4 which are disposed inside the device main body 2. The main power source unit 3 supplies a power to each of the corresponding internal constituent elements, and its substrate (not shown) is accommodated in a box 31. The lamp unit 4 has a lamp 43 including a light-emitting tube 41 (refer to FIG. 5) and a reflector 42 (refer to FIG. 5), and a lamp holder 44 for holding the lamp 43.

A light emitted from the light-emitting tube 41 is condensed by the reflector 42 and unnecessary radiations such as an infrared radiation and an ultraviolet radiation are filtered by a filter. After this, the resulting light is spectrally diffracted into an R light, a G light and a B light by a condenser lens, a reflecting mirror, a dichroic mirror and the like. After the resulting R light, G light and B light obtained through the spectral diffraction penetrate through a liquid crystal panel for R, a liquid crystal panel for G, and a liquid crystal panel for B, respectively, they are optically multiplexed by a dichroic prism and the like, and the resulting image light obtained through the optical multiplexing is projected on a screen or the like by a projection lens 5.

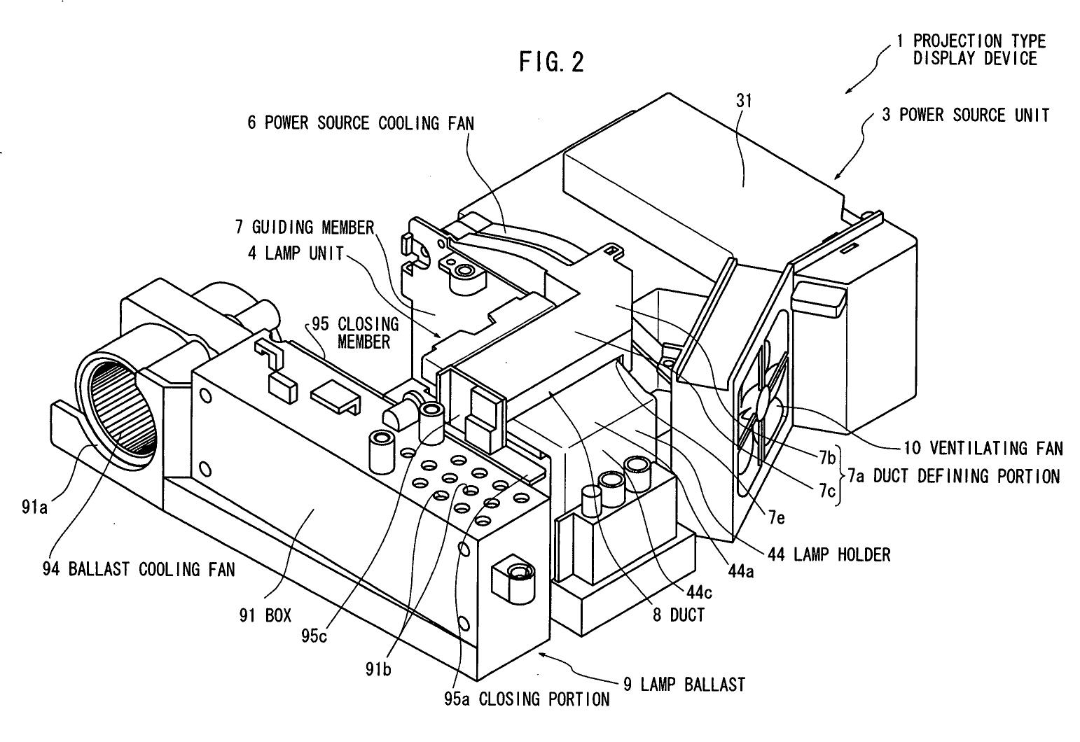

FIG. 2 is a partial perspective view showing the projection type display device according to the embodiment of the invention.

As shown in FIG. 2, the projection type display device 1 includes a fan 6 for a main power source which cools the main power source unit 3, and a guiding member 7 which is connected to the fan 6 for a main power source and which guides air to the lamp unit 4 and the like. Also, a duct defining portion 7a of the guiding member 7, and an upper surface 44a of the lamp holder 44 define a duct 8 for guiding the air which is caused to circulate when the fan 6 for a main power source is driven. That is to say, the duct 8 is defined on the outside surface of the lamp holder 44. In addition, the fan 6 for a main power source supplies the air as a cooling medium to each of the main power source unit 3 and the lamp unit 4.

As shown in FIG. 1, in this embodiment, the main power source unit 3 is installed in a corresponding corner portion of the device main body 2, the fan 6 for a main power source is disposed more inside than the main power source unit 3 is disposed. The fan 6 for a main power source is a sirocco fan and is disposed between the main power source unit 3 and the duct 8.

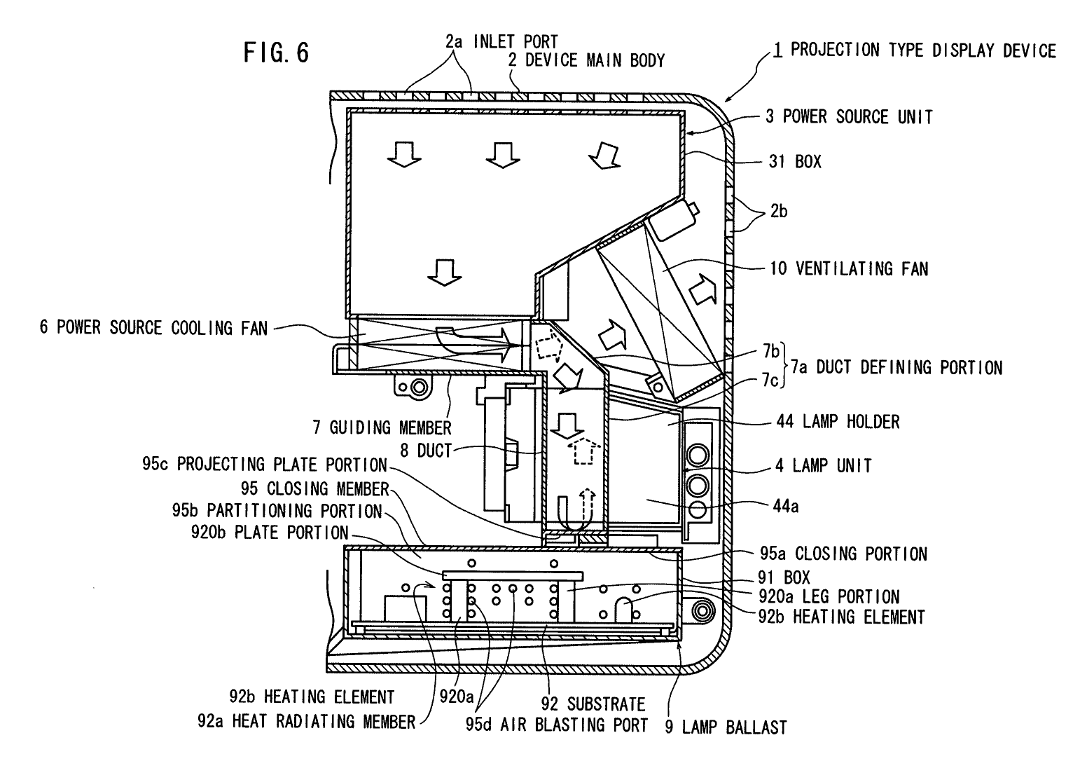

In addition, as shown in FIG. 1, a lamp power source unit 9 is disposed in the rear of the lamp unit 4 to be adjacent to the lamp unit 4. The lamp power source unit 9 supplies a power to the lamp 43, and its substrate 92 (refer to FIG. 6) is accommodated in the box 91. In this embodiment, the lamp power source unit 9 is disposed in a right backward corner portion of the device main body 2.

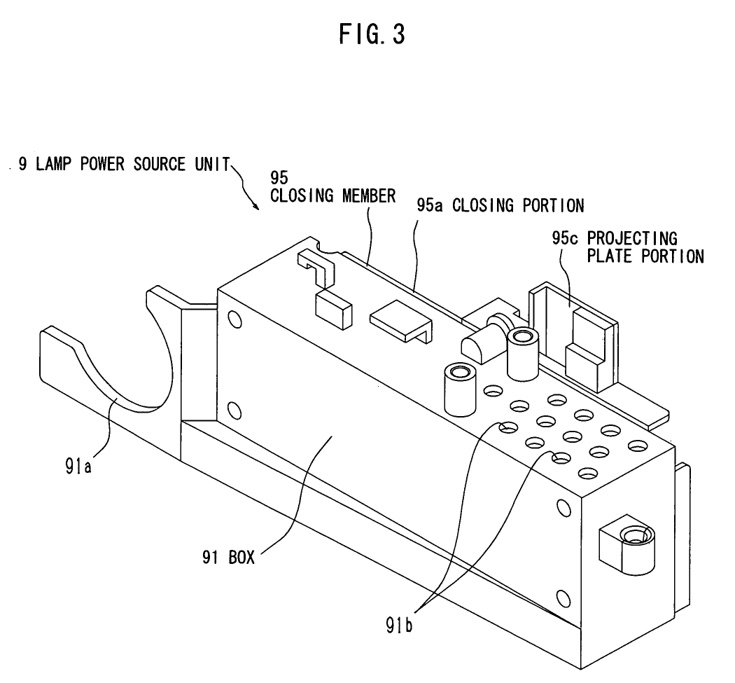

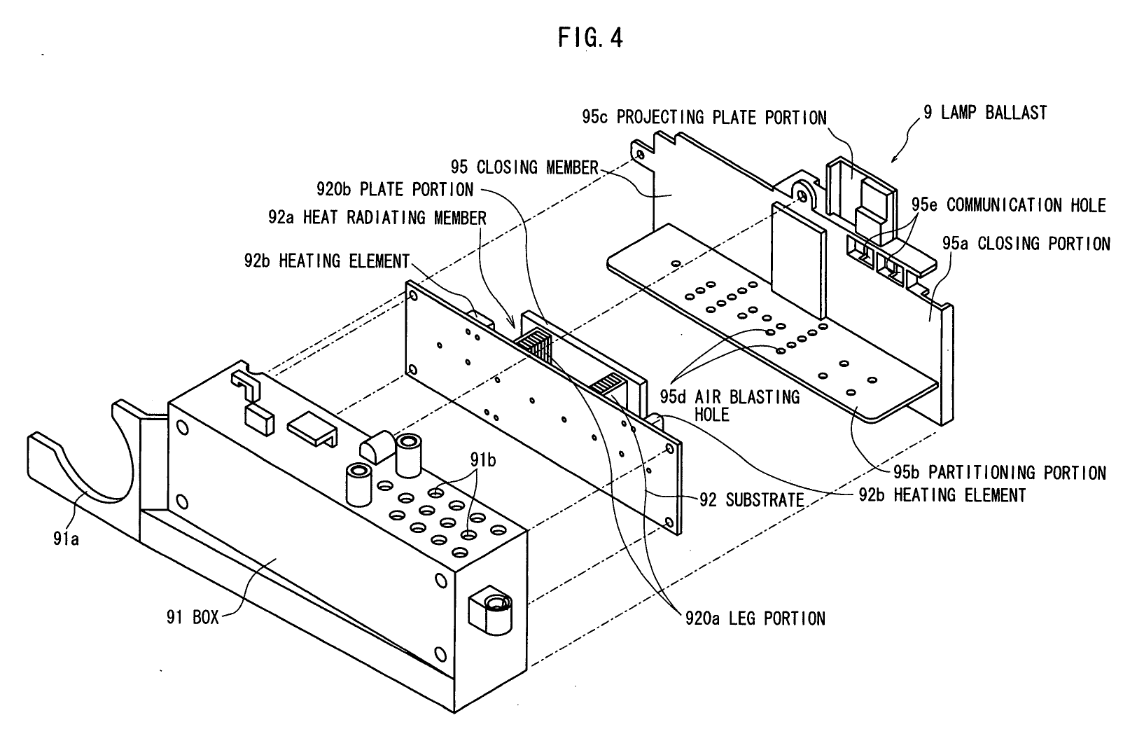

FIG. 3 is a perspective view showing an exterior appearance of the lamp power source unit, and FIG. 4 is an exploded perspective view of the lamp power source unit.

As shown in FIG. 3, a connection portion 91a to which a fan 94 for a lamp power source is connected is connected to a left-hand side of the box 91 of the lamp power source unit 9, so that each of elements mounted to the substrate 92 provided inside the box 91 is cooled. In addition, as shown in FIG. 4, the substrate 92 is fixed to the rear surface of the box 91 with vises or the like, and a plurality of heating elements 92b are mounted to a mounting surface of the substrate 92. In this embodiment, one of the heating elements 92b is a heat radiating member 92a having a fin-like shape.

As shown in FIG. 4, the lamp unit 4 side (front side) of the box 91 is opened, and this opening is closed by a closing member 95. The fan 94 for a lamp power source is a sirocco fan and sends the air to the lower side of the box 91. The closing member 95 includes a closing portion 95a for closing the front of the box 91, and a plate-like partitioning portion 95b for partitioning the inside of the box 91 into upper and lower parts. The partitioning portion 95b partitions the inside of the box 91 into an air inflow space (refer to FIG. 5) into which the fan 94 for a lamp power source causes the air to flow, and a substrate accommodating space 102 (refer to FIG. 5) in which the substrate 92 is accommodated. A projecting plate portion 95c which projects upward is formed in the closing portion 95a. In this embodiment, the box 91 is lower in height than the duct 8, so that the rear end of the duct 8 is closed by the projecting plate portion 95c.

A plurality of discharge holes 95d each having a round shape are formed in the partitioning portion 95b. The plurality of discharge holes 95d are disposed longitudinally and transversely so as to correspond to a heat radiating member 92a and heating elements 92b. One of the heating elements 92b, for example, is a resistor. The air is blown to each of the heat radiating member 92a and the heating elements 92b through the discharge holes 95d. Here, the heat radiating member 92a most projects from the substrate 92 among the associated elements, including the heating elements 92b. Also, the heat radiating member 92a has a pair of leg portions 920a each projecting from the substrate 92, and a plate portion 920b to which projection ends of both the leg portions 920a are connected. A fin having a heat radiating shape is formed in each of the leg portions 920a, and the plurality of discharge holes 95d are formed in parallel so as to overlap in position the fin when viewed from the upper surface.

FIG. 5 is a partial longitudinal explanatory sectional view, of the projection type display device, showing a flow of the air caused by the fan for a lamp power source.

As shown in FIG. 5, the air sent out from the fan 94 for a lamp power source is caused to circulate in a right-hand direction in a lower side of the partitioning portion 95b. The discharge holes 95d described above are formed in the partitioning portion 95b, and thus the air enters the upper side of the partitioning portion 95b through the discharge holes 95d. Here, the discharge holes 95d are formed so as to overlap in position the heating elements 92b, respectively, when viewed from the upper surface. Thus, the air entered the upper side of the partitioning portion 95b is blown to the individual heating elements 92b.

A plurality of exhaust holes 91b through which the air in the upper side of the partitioning portion 95b in the box 91 is discharged are formed in the upper surface of the box 91. Each of the exhaust holes 91b is formed in round shape when viewed from the upper surface. Moreover, communication holes 95e through which the substrate accommodating space 102 within the box 91 communicates with the lamp unit 4 side are formed in the closing portion 95a. The air which has taken the heat away from each of the heating elements 92a is discharged to the outside of the lamp power source unit 9 through the exhaust ports 91b and the communication holes 95e. Also, the air in the box 91 is caused to flow out to the inside of the lamp unit 4 through the communication holes 95e.

Specifically, the two communication holes 95e are provided in parallel on the left-hand and right-hand sides, respectively, and are formed so as to overlap in position the light-emitting tube 41 of the lamp 43 when viewed from the front. As a result, the air which has flowed out through the communication holes 95e performs the heat exchange with the light-emitting tube 41. In this embodiment, each of the communication holes 95e is formed in rectangular shape when viewed from the front.

Here, a description will now be given with respect to a flow of the air as well caused by the fan for a main power source.

FIG. 6 is a partial transverse explanatory sectional view, of the projection type display device, showing a flow of the air caused by the fan for a power source.

As shown in FIG. 6, when the fan 6 for a main power source is driven, the air is caused to flow into the box 31 of the main power source unit 3 through inlet ports 2a formed in the vicinity of the main power source unit 3 of the device main body 2. After this, a part of the air the heat exchange for which is performed with each of the heating elements or the like disposed in the box 31 is caused to circulate backward in the duct 8 by the operation of the fan 6 for a main power source, and then moves forward within the lamp holder 44. After the air caused to flow out from the lamp holder 44 meets the remainder of the air the heat exchange for which has been performed with each of the heating elements or the like disposed in the box 31, the resulting air is discharged to the outside of the projection type display device 1 through exhaust ports 2b of the device main body 2 by a ventilating fan 10 which will be described later.

Specifically, the fan 6 for a main power source rotates with a direction of inflow of the air from the main power source unit 3 (a longitudinal direction in FIG. 1) as an axis, and absorbs axially the air within the main power source unit 3 and sends radially the air thus absorbed. In this embodiment, the air is sent out in a direction (in a right-hand direction in FIG. 1) along the box 31 of the main power source unit 3.

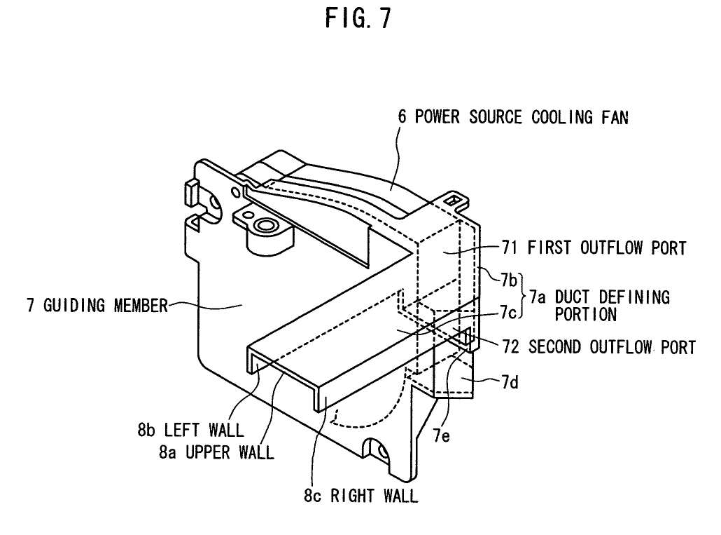

FIG. 7 is a perspective view showing an exterior appearance of the guiding member having the duct defining portion, and the fan for a main power source.

As shown in FIG. 7, the guiding member 7 is mounted to an outer hull member of the fan 6 for a main power source, and defines, together with the outer hull member of the fan 6 for a main power source, a first outflow port 71 through which the air is caused to flow out to the duct 8, and a second outflow port 72 through which the air is caused to flow out to the exhaust ports 2b formed in the device main body 2. Specifically, the guiding member 7 divides the air outflow port formed in the outer hull member of the power source cooling fan 6 into upper and lower parts. In this embodiment, a flow division ratio of the air outflow through the first outflow port 71 to the air outflow through the second outflow port 72 is set nearly as 1:1.

FIG. 7 also shows an exterior appearance of the guiding member. The guiding member 7 is made of a plastic material containing therein glass, and is excellent in heat resistance and heat conduction property.

The duct defining portion 7a of the guiding member 7 has a bending section 7b which is formed continuously with the first outflow port 71 and which bends right backward, and an extension section 7c which straight extends backward from the bending section 7b. The duct defining portion 7a is formed with its lower surface being released so as to form an upper wall 8a, a left wall 8b and a right wall 8c of the duct 8. In this embodiment, the duct defining portion 7a is disposed slightly apart from an upper surface 44a of the lamp holder 44, so that the air slightly flows out through the duct 8. Here, a lower side of the extension section 7c on the bending section 7b side is formed in the form of a stepped portion 7e when viewed from the side face. The stepped portion 7e abuts against a corresponding corner portion of the lamp holder 44, thereby positioning the guiding member 7 and the lamp holder 44 in place. In addition, the guiding member 7 has a plate portion 7d which is formed continuously with the right wall 8c of the extension section 7c, and which guides the air flowed out through the first outflow port 72 to the exhaust ports 2b.

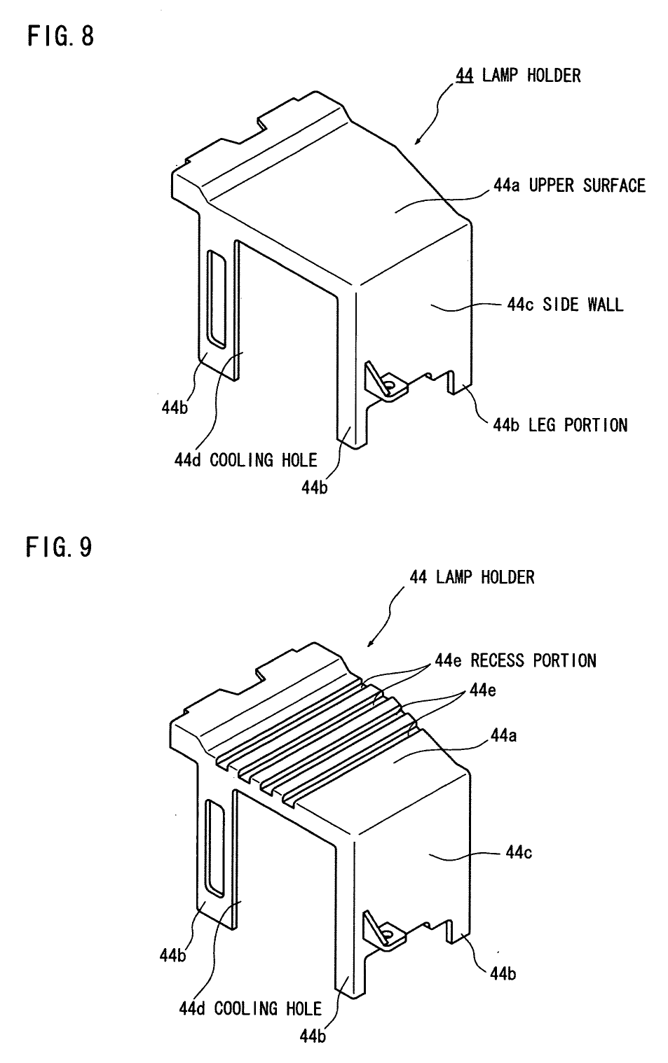

FIG. 8 is a perspective view showing an exterior appearance of the lamp holder. The lamp holder 44 is made of a plastic material containing therein glass, and is excellent in heat resistance and heat conduction property.

As shown in FIG. 8, the lamp holder 44 has an upper surface 44a which is formed nearly in rectangular shape when viewed from the plane, and four leg portions 44b which extend downward from respective corner portions of the upper surface 44a. In this embodiment, the lamp holder 44 has a right surface 44b formed thereon, and the left side thereof is nearly closed by the lamp 43 during assembling of the lamp 43. Hence, a circulation path of the air is defined inside the lamp holder 44 in the longitudinal direction. Cooling holes 44d through which the air is caused to circulate are formed in the front surface and the back surface of the lamp holder 44, respectively. The backward cooling hole 44d is an opening for cooling through which the air circulated in the duct 8 is guided to the inside of the lamp holder 44.

In addition, the embodiment described above has shown that the upper surface 44a of the lamp holder 44, as shown in FIG. 8, is formed to be nearly flat. Instead, as shown in FIG. 9, for example, recess portions 44e may be formed on the upper surface 44a of the lamp holder 44 to obtain the fin-shaped upper surface 44a, thereby increasing a surface area of the upper surface 44a which contacts the circulating air. As a result, it is possible to enhance the efficiency of the heat exchange between the circulating air and the lamp holder 44. In addition, even when convex portions are formed instead of the recess portions 44e, it is possible to obtain the same effect as that in the case of the construction having the recess portions 44e.

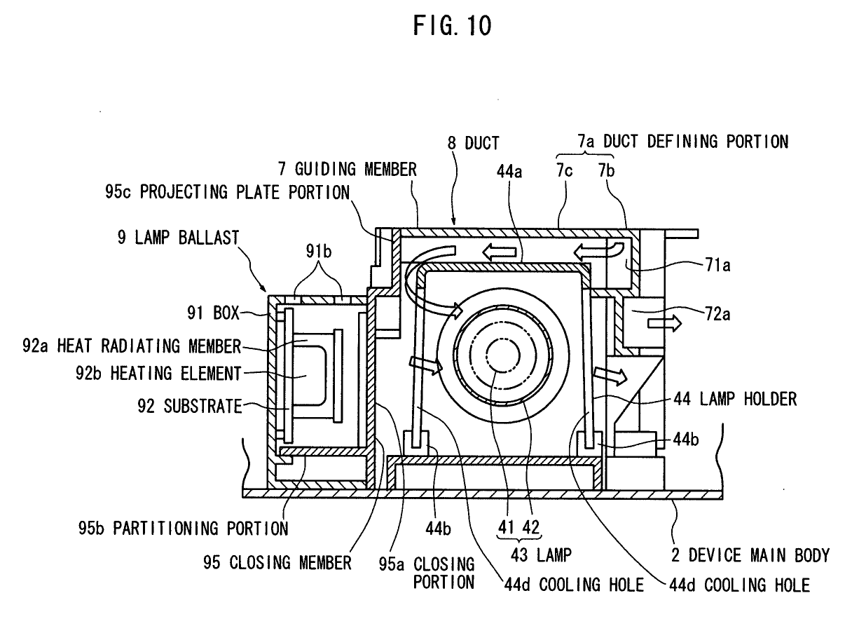

FIG. 10 is a partial longitudinal explanatory sectional view, of the projection type display device, showing a flow of the air sent out from the fan for a main power source.

As shown in FIG. 10, the lamp holder 44 and the lamp power source unit 9 are disposed apart from each other, and the duct defining portion 7a of the guiding member 7 is formed so as to project backward with respect to the lamp holder 44. As a result, the air which has been caused to circulate in the duct 8 changes its flow direction to a downward direction from a surface of a projecting plate portion 95c of the lamp power source unit 9 and flows into the lamp holder 44 through a gap defined between the lamp holder 44 and the lamp power source unit 9, and the air cooling hole 44d.

After the air flowed into the lamp holder 44 flows out in front of the lamp holder 44 via the surface of the reflector 42 within the lamp holder 44, it meets the air flowed out through the second outflow port 72 described above and flows out to the outside of the projection type display device 1 through the exhaust ports 2b formed in the right wall of the device main body 2. In this embodiment, the ventilating fan 10 is provided on this side of the exhaust ports 2b, and the air is discharged to the outside of the projection type display device 1 with the assistance of the ventilating fan 10.

In the projection type display device 1 constructed in the manner as described above, when the fan 9 for a lamp power source is driven, the air is caused to flow into the air inflow space 101 of the box 91. The air thus flowed thereinto is discharged toward the substrate accommodating space 102 through the discharge holes 95d formed in the partitioning portion 95b. At this time, since the circulation path of the air is narrowed by the discharge holes 95d, a high flow velocity can be obtained during the discharge of the air. Also, since the air which has been discharged to the substrate accommodating space 102 is discharged toward the heat radiating member 92a and the heating elements 92b, air is not discharged to any of the portions which do not need to be cooled, and thus it is possible to efficiently cool each of the heating portions in the lamp power source circuit 9. In particular, since the air is discharged to the heat radiating member 92a having a satisfactory heat exchange efficiency, it is possible to obtain the extremely high efficiency of cooling the lamp power source unit 9.

Consequently, each of the heating portions disposed in the lamp power source unit 9 can be efficiently cooled to lighten the burden imposed on the fan 94 for a lamp power source, and thus the miniaturization of the fan 94 for a lamp power source, and the reduction in noises and power consumption can be realized.

In addition, the air is caused to flow out from the box 91 through the communication holes 95e to cool the lamp unit 4. Therefore, not only the lamp power source unit 9 can be cooled, but also the lamp unit 4 can be cooled by using the fan 94 for a lamp power source. In this embodiment, since the lamp unit 4 is also cooled by the fan 6 for a main power source, it is unnecessary to provide a fan dedicated to the lamp unit 4 in the lamp unit 4. As a result, it is possible to reduce the number of components or parts.

In addition, taking a view of the air sent out from the fan 6 for a main power source, since the lower surface of the duct 8 is defined by the lamp holder 44, the heat exchange is performed between the circulating air and the lamp holder 44 so that the circulating air takes the heat away from the lamp holder 44. As a result, it is possible to obtain the operation for cooling the ambient atmosphere or the like of the lamp 43 held by the lamp holder 44, and the lamp holder 44 as well as the cooling for the lamp holder 44.

In addition, the air which is caused to circulate in the lamp unit 4 is turned up, so that the lamp holder 44 is cooled and the reflector 42 of the lamp 43 is also cooled by the fan 6 for a main power source. Therefore, the extremely satisfactory efficient of the heat exchange is obtained. Also, the operations for cooling the portions to be cooled in the lamp unit 4 are allotted to the fan 6 for a main power source and the fan 94 for a lamp power source, respectively, so that the fan 94 for a lamp power source cools the light-emitting tube 41 of the lamp 43, and the fan 6 for a main power source cools the reflector 42 of the lamp 43. As a result, the exact cooling for the lamp unit 4 is realized.

Note that, the embodiment described above has shown that the partitioning portion 95b having the discharge holes 95d formed therein is provided in the lamp power source unit 9. However, it is to be understood that the partitioning portion may be provided in the main power source circuit 3. That is to say, the invention can be applied to the power source unit as long as it has a substrate.

In addition, the embodiment described above has shown that the partitioning portion 95b is formed in the closing member 95 which closes the open surface of the box 92. However, for example, the plate-like partitioning portion may be inserted into the box having no open surface, or the partitioning portion may be formed integrally with the box having no open surface. In this case, a method of forming the partitioning portion may be arbitrarily implemented.

Also, the embodiment described above has shown that the partitioning portion 95b partitions the inside of the box 91 into the air inflow space 101 and the substrate accommodating space 102. In this case, the position where the partition is made by the partitioning portion is arbitrarily determined. For example, a construction may also be adopted such that the partitioning portion 95b is provided so as to straddle the substrate 92, and the discharge holes 95d are made to come close to the heat radiating member 92a and the heating elements 92b.

In addition, although it is shown in the embodiment described above that each of the discharge holes 95d is formed in circular shape, and each of the communication holes 95e is formed in rectangular shape, the shape of the discharge holes 95d, and the shape of each of the communication holes 95e are arbitrarily determined. Also, when there is no need for cooling the lamp unit 4, the communication holes 95e may be omitted.

In addition, although the embodiment described above has shown that the fan 94 for a lamp power source sends the air to the inside of the box 91, the fan 94 for a lamp power source may also absorb the air from the inside of the box 91. In a word, any type of the fan 94 for a lamp power source may be adopted as long as it causes the air to flow into the box 91. Moreover, the type of the fan 94 for a lamp power source, the circulation direction of the air within the box 92, and the like are also arbitrarily set. Also, it is to be understood that other concrete constructions or the like of the details can also be suitably changed.

It should be noted that the present invention is not limited to the embodiments described above, and the various combinations and changes may be made without departing from or changing the technical idea of the present invention.

What is claimed is:

1. A power source unit for a projection type display device, comprising:
a box for accommodating therein a substrate having a heating element mounted thereon;
a fan for causing air to flow into the box; and
a partitioning portion for partitioning an inside of the box, a discharge hole through which the air is blown to the heating element being formed in the partitioning portion.

2. A power source unit for a projection type display device according to claim 1, wherein the partitioning portion partitions an inside of the box into an air inflow space into which the air is caused to flow by the fan, and a substrate accommodating space in which the substrate is accommodated.

3. A power source unit for a projection type display device according to claim 2, wherein the fan sends out the air to the air inflow space.

4. A power source unit for a projection type display device according to claim 2, wherein the fan absorbs the air from the substrate accommodating space.

5. A power source unit for a projection type display device according to claim 1, wherein a heat radiating member is mounted together with the heating element to the substrate, and the air is blown to each of the heating element and the heat radiating member through the discharge hole.

6. A power source unit for a projection type display device according to claim 1, wherein one or plural holes are formed as the discharge holes in the partitioning portion in accordance with a shape of the heating element, and the air is blown to the heating element through the one or plural holes.

7. A power source unit for a projection type display device, comprising:
a box for accommodating therein a substrate having a heating element mounted thereon, one face of the box being opened;
a fan for causing air to flow into the box;
a closing member for closing the opening of the box; and
a partitioning portion for partitioning an inside of the box, a discharge hole through which the air is blown to the heating element being formed in the partitioning portion.

8. A power source unit for a projection type display device according to claim 7, wherein the partitioning portion partitions an inside of the box into an air inflow space into which the air is caused to flow by the fan, and a substrate accommodating space in which the substrate is accommodated.

9. A power source unit for a projection type display device according to claim 8, wherein the fan sends out the air to the air inflow space.

10. A power source unit for a projection type display device according to claim 8, wherein the fan absorbs the air from the substrate accommodating space.

11. A power source unit for a projection type display device according to claim 7, wherein a heat radiating member is mounted together with the heating element to the substrate, and the air is blown to each of the heating element and the heat radiating member through the discharge hole.

12. A power source unit for a projection type display device according to claim 7, wherein one or plural holes are formed as the discharge holes in the partitioning portion in accordance with a shape of the heating element, and the air is blown to the heating element through the one or plural holes.

13. A projection type display device, comprising:
power source unit including a box for accommodating therein a substrate having a heating element mounted therein, a fan for causing air to flow into the box, and a partitioning portion for partitioning an inside of the box, a discharge hole through which the air is blown to the heating element being formed in the partitioning portion;
a lamp unit disposed to be adjacent to the power source unit; and
a communication hole formed in the power source unit, the air in the box being caused to flow out to an inside of the lamp unit through the communication hole.

14. A projection type display device according to claim 13, wherein the partitioning portion partitions an inside of the box into an air inflow space into which the air is caused to flow by the fan, and a substrate accommodating space in which the substrate is accommodated.

15. A projection type display device according to claim 14, wherein the communication hole is formed on an area surface which defines the substrate accommodating space of the box.

16. A projection type display device according to claim 14, wherein the fan sends out the air to the air inflow space.

17. A projection type display device according to claim 14, wherein the fan absorbs the air from the substrate accommodating space.

18. A projection type display device according to claim 13, wherein a heat radiating member is mounted together with the heating element to the substrate, and the air is blown to each of the heating element and the heat radiating member through the discharge hole.

19. A projection type display device according to claim 13, wherein one or plural holes are formed as the discharge holes in the partitioning portion in accordance with a shape of the heating element, and the air is blown to the heating element through the one or plural holes.
